(19) United States
(12) Patent Application Publication
(10) Pub. No.: US 2008/0080879 A1
(43) Pub. Date: Apr. 3, 2008

(54) Charging device uniformity measurement system

(75) Inventor: Michael F. Zona, Holley, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/528,885

(22) Filed: Sep. 28, 2006

(51) Int. Cl. G03G 15/02

(52) U.S. Cl. 399/31

(57) ABSTRACT

A method and apparatus for accessing the uniformity of a charging subsystem with a resolution which enables one to make accurate predictions of customer acceptance of the charging device. The method and apparatus employs a scanner that scans the light emitted from a recording member such as a phosphor coated substrate while the charging device under test is in operation against the substrate, the uniformity of device can be processed using off-the-self image analysis tools. This enables imaging the generated charge pattern with improved spatial resolution and offers a quantitative technique to measure charge uniformity.

### TECHNICAL FIELD

The present disclosure relates generally to charging devices which may be used in an electrophotographic printing machine, and more particularly concerns method and apparatus for testing the performance characteristics of the charging devices.

### BACKGROUND

In a typical electrophotographic printing process, a photoconductive member is charged to a substantially uniform potential so as to sensitize the surface thereof. The charged portion of the photoconductive member is exposed to a light image of an original document being reproduced. Exposure of the charged photoconductive member selectively dissipates the charges thereon in the irradiated areas. This records an electrostatic latent image on the photoconductive member corresponding to the informational areas contained within the original document. After the electrostatic latent image is recorded on the photoconductive member, the latent image is developed by bringing a developer material into contact therewith. Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet. The toner particles are heated to permanently affix the powder image to the copy sheet. In printing machines such as those described above, corona devices perform a variety of other functions in the printing process. For example, corona devices aid the transfer of the developed toner image from a photoconductive member to a transfer member. Likewise, corona devices aid the conditioning of the photoconductive member prior to, during, and after deposition of developer material thereon to improve the quality of the electrophotographic copy produced thereby. Both direct current (DC) and alternating current (AC) type corona devices are used to perform these functions.

One form of a corona charging device comprises a corona electrode in the form of an elongated wire connected by way of an insulated cable to a high voltage AC/DC power supply. The corona wire is partially surrounded by a conductive shield. The photoconductive member is spaced from the corona wire on the side opposite the shield. An AC voltage may be applied to the corona wire and at the same time, a DC bias voltage is applied to the shield to regulate ion flow from the corona wire to the photoconductive member being charged.

Another form of a corona charging device is pin corotrons and scorotrons. The pin corotron comprises an array of pins integrally formed from a sheet metal member that is connected by a high voltage cable to a high power supply. The sheet metal member is supported between insulated end blocks and mounted within a conductive shield. The photoconductive member to be charged is spaced from the sheet metal member on the opposite side of the shield. The scorotron is similar to the pin corotron, but is additionally provided with a screen or control grid disposed between a coronode and the photoconductive member. The screen is held at a lower potential approximating the charge level to be placed on the photoconductive member. The scorotron provides for more uniform charging and prevents over charging.

Still other forms of corona charging devices include bias charging rolls (BCR) configured so as to include an inner conductive member having a layer of high electrical resistance material for applying a uniform charge on the photoreceptor surface prior to light exposure of the latent image. Also such a roller member can be used for transferring the developed toner image to a substrate.

The critical aspect of all corona charging devices focuses on maintaining the same pattern and intensity of electrostatic fields whether in charging on the photoconductive member or in transfer of the developed image to a substrate. Failure to maintain the above criterion can create print defects.

In the prior art, one method to access the voltage uniformity of a charging device is to generate halftone images in a xerographic system. This method requires that the device be able to be mounted and operate in a finished system that is capable of generating prints. However, this method is not available when the charging device is under development without significant design and build resources in order to fit the device into a working system.

An alternative offline method to access uniformity include charging Mylar as a surrogate to machine testing (or charging an actual photoreceptor) and measuring the resulting voltage using an electrostatic voltmeter. This method employs voltmeters that typically have a spatial resolution of three to five millimeters which limits their ability to accurately predict customer acceptance once the device has been integrated into a system and making prints. Charging Mylar has the advantage of not having to worry about dark decay or light induced discharge since the charge remains on the Mylar indefinitely. Both methods require the use of an electrostatic voltmeter (ESV) to scan the surface of the photoconductive member or Mylar and measure the voltage.

One of the major drawbacks of current ESV technology is the limited resolution of the probe. Depending on how close the probe is to the surface being measured, the actual surface area being measured can range from two to five millimeters in diameter. The output of the ESV is the average voltage of the two to five millimeter circle. In practice, it would be preferred to obtain the voltage variation across the process direction down to the millimeter, or sometimes less.

This problem with ESV is particularly acute in determining voltage uniformity for pin charging devices, since pin charging devices used for charging have a typical pin to pin distance of two to three millimeters. The ESV probe tends to level out the peaks and valleys in the generated charge pattern. Therefore, it is highly desirable to provide a measurement system for charge patterns that do not suffer the spatial resolution issues of ESVs. Also, it is highly desirable to provide a measurement system that does not require the full xerographic system to be in operation so that development testing and optimization can be completed in parallel with other subsystem development.

### SUMMARY

The present invention obviates the problems noted above by providing a method and apparatus for accessing the uniformity of a charging subsystem with a resolution which enables one to make accurate predictions of customer acceptance of the charging device. The method and apparatus employs a scanner that scans the light emitted from a recording member such as a phosphor coated substrate while the charging device under test is in operation against the substrate, the uniformity of device can be processed using off-the-self image analysis tools. This enables imaging the generated charge pattern with improved spatial resolution and offers a quantitative technique to measure charge uniformity.

There has been provided a method for measuring performance output of a charging device, comprising: providing a recording surface having means for illuminating when exposed to corona discharge; charging a portion of the recording surface with a charging device to obtain an illumination pattern on the portion of the recording surface; scanning said illumination pattern on the portion of the recording surface; and determining performance characteristics of said charging device from said scanned illumination pattern.

There has also been provided an apparatus for measuring performance output of a charging device, comprising: a recording surface having means for illuminating when exposed to corona discharge, wherein the charging device charges a portion of the recording surface to obtain an illumination pattern on the portion of the recording surface; and a scanner for scanning said illumination pattern on the portion of the recording surface.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is an elevational view of the apparatus for testing the performance characteristics of the charging devices of the present disclosure.

FIG. 2 is a side view of a recording member having a surface which illuminates when exposed to corona discharge.

FIGS. 3 and 4 are scanned images captured by employing the principles of the present disclosure.

### DETAILED DESCRIPTION

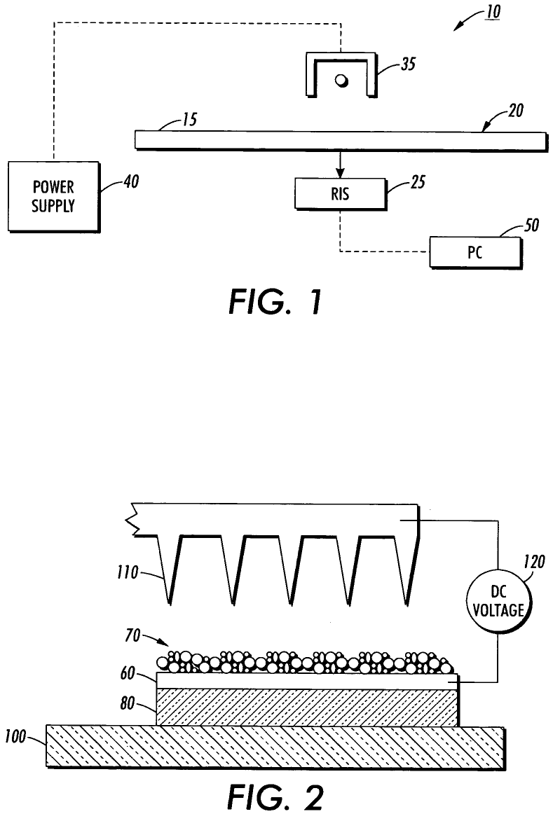

Referring to FIG. 1 which is a simplified elevational view showing relevant elements of the charging device test fixture of the present disclosure. Test fixture 10 includes recording member 15 having an illumination surface 20 that emits light when exposed to ions that are generated by corona formation. Scanner 25 is positioned adjacent to illumination surface 20. Test fixture 10 includes a mounting assembly (not shown), mounting assembly supports charging device 35 to be tested in an operatably position relative to illumination surface 20 and also allows charging device 35 to be readily remove therefrom. Power supply 40 is connected to charging device 35 and supplies a desired high voltage to generate corona from charging device 35. Scanner 25 captures the illumination pattern generated when ions that are generated by corona formation come in contact with illumination surface 20, and sends the captured illumination pattern to PC 50.

PC 50 can display the captured illumination pattern on display screen or preferably PC 50 includes software which can analyze the captured illumination pattern and correlates the captured illumination pattern to performance characteristics of the charging device being tested. Many image analysis software packages, like Adobe Photoshop, have the capability to import the captured illumination pattern and digitally assess the uniformity of pattern through pixel analysis. The software can also provide the user a quantitative measure of the patterns uniformity based on the aforementioned pixel analysis.

Referring now to FIG. 2, the applicant has tested a recording member consisting of planar glass plate 80 coated with a translucent conductive coating 60 (i.e. indium tin oxide (ITO). On the coating is a second coating of phosphor particles 70 that can range in size from three nanometers to many microns. The glass is placed, phosphor side up, onto the scanner platen. The conductive coating is electrically connected to ground (or any appropriate voltage to simulate the photoconductive member voltage). The charging device under test is placed at the appropriate spacing over the phosphor substrate and supplied the desired high voltage. The ions generated by the device collide with the phosphor particles causing them to emit light. This light is then captured by the scanner and can be analyzed using commercially available software. The resolution of the scanned image is only limited by the size of the phosphor particles and the resolution of the CCD in the scanner being used. Both are many orders of magnitude smaller than what would typically be required for good charge device characterization.

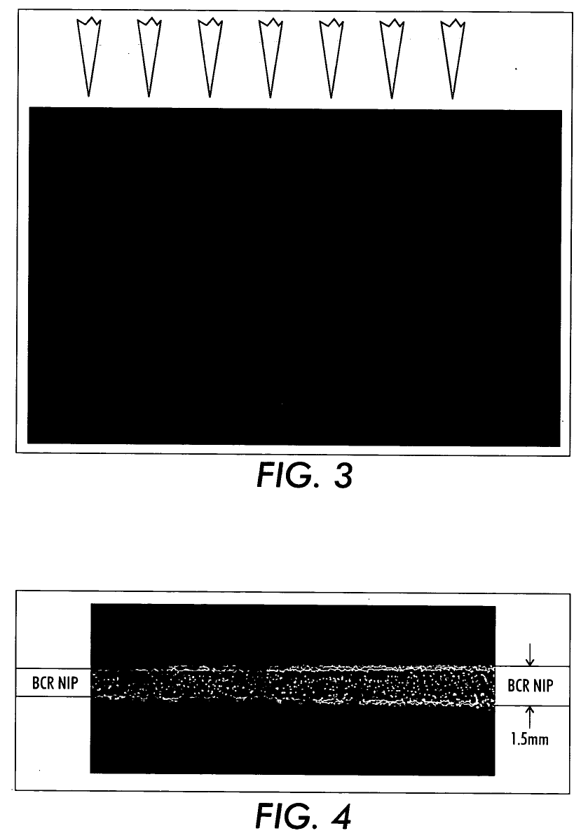

Principles of the present disclosure were tested on an Epson 1600 scanner with an ITO coated microscope slide. The scanner light was turned off during the scan operation in order for the CCD to capture the light emitted from the phosphor, instead of the reflected light of the scanner lamp. A layer of P-47 phosphor dispersed in isopropyl alcohol is spray coated onto the ITO surface and allowed to dry for 5 to 10 minutes, leaving a semi-uniform layer of phosphor powder on the slide. The slide is then placed on the scanner bed and the conductive surface is electrically connected to ground. In example number 1, a DC490 detack device is placed over the slide at a spacing of three millimeters. A high voltage of 5 kV is applied to the pin array and −600 volts is applied to shield. With the scanner lamp off, the phosphor coated slide is scanned from the back to capture the emitted light that is formed from the generated charge pattern. Referring to FIG. 3, Applicant has found a correlation of the pin tips of charging device relative to the generated pattern captured. The circled area illustrates the lower charged lines that occur between each of the pin tips. In this case, the tips are three millimeters apart from each other. In normal ESV scanning, the probe would not be able to resolve these charge deficient lines due to the large aperture of the probe.

Referring to FIG. 4, a second example was done using a bias charge roll. In this case the roll was placed in contact with slide. An AC voltage of 2 kV pk-pk was applied to the BCR and the resulting charge pattern was captured in a similar fashion to example one. The BCR was placed on the phosphor slide to capture the charge pattern. As illustrated in FIG. 4, the higher intensity charge exchange at the edges of the nip formed at the BCR contact points. In addition, one can see the very small charge exchange points within the nip that are likely created by small air gaps between the BCR surface and the substrate. In testing, applicant had the BCR pressure against the substrate different at each end of the BCR in order to illustrate that the charge pattern changes as a function of pressure (wide on the right, thinner on the left).

In recapitulation, there has been provided a method and apparatus for accessing the uniformity of a charging subsystem with a resolution which enables one to make accurate predictions of customer acceptance of the charging device. The method and apparatus employs a scanner that scans the light emitted from a recording member such as a phosphor coated substrate while the charging device under test is in operation against the substrate, the uniformity of device can be processed using off-the-self image analysis tools. This enables imaging the generated charge pattern with improved spatial resolution and offers a quantitative technique to measure charge uniformity.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A method for measuring performance output of a charging device, comprising:
providing a recording surface having means for illuminating when exposed to corona discharge;
charging a portion of the recording surface with a charging device to obtain an illumination pattern on the portion of the recording surface;
scanning said illumination pattern on the portion of the recording surface; and
determining performance characteristics of said charging device from said scanned illumination pattern.

2. The method of claim 2 wherein said scanning includes optically reading said illumination pattern on said recording surface.

3. The method of claim 2, further comprising positioning said charging device facing on one side of the surface said recording and said scanner on the opposed side of the surface.

4. The method of claim 1, further comprising providing said recording surface having a phosphor coating on a substrate.

5. An apparatus for measuring performance output of a charging device, comprising:
a recording surface having means for illuminating when exposed to corona discharge, wherein the charging device charges a portion of the recording surface to obtain an illumination pattern on the portion of the recording surface; and
a scanner for scanning said illumination pattern on the portion of the recording surface.

6. The apparatus of claim 5, further comprising means for determining performance characteristics of said charging device from said scanned illumination pattern.

7. The apparatus of claim 5, wherein the charging device is disposed facing on one side of the surface said recording and said scanner on the opposed side of the surface.

8. The apparatus of claim 5, wherein said recording surface has a phosphor coating on a substrate.

9. The apparatus of claim 8, wherein said recording surface further includes a conductive coating.

10. The apparatus of claim 9, further comprising means for biasing said conductive coating.
